(19) United States
(12) Patent Application Publication
(10) Pub. No.: US 2012/0229948 A1
(43) Pub. Date: Sep. 13, 2012

(54) Capacitor Used as Insulating Spacer for a High Current Bus Structure

(75) Inventors: Edward Sawyer, Barre, VT (US); Terry Hosking, Barre, VT (US); Michael Brubaker, Loveland, CO (US)

(73) Assignee: S B E, INC., Barre, VT (US)

(21) Appl. No.: 13/415,334

(22) Filed: Mar. 8, 2012

Related U.S. Application Data
(60) Provisional application No. 61/451,647, filed on Mar. 11, 2011.

(51) Int. Cl. H01G 4/002

(52) U.S. Cl. 361/301.1

(57) ABSTRACT

Parallel plate bus structures are commonly used for high-current applications where low inductance is a requirement. Such bus structures are very well suited for inverter topologies used to convert from DC to AC power and a capacitor is needed to minimize ripple on the DC bus. The present invention provides a method of integrating an annular form factor wound film capacitor into a parallel bus structure to provide a compact geometry with minimal inductance. Furthermore, the capacitor acts as the dielectric spacer between the bus plates, which eliminates the need for separate capacitor terminals and provides the lowest possible profile.

This application is a non-provisional of U.S. provisional application 61/451,647 “Capacitor Used as Insulating Spacer for a High Current Bus Structure” filed Mar. 11, 2011. This application claims all priority and benefit of the preceding provisional application.

### FIELD OF THE INVENTION

The present invention relates to the use of a wound polymer film capacitor having an annular form factor which is used as the dielectric spacer between two parallel bus plates. The capacitor is electrically in parallel with the bus to provide stored energy and a low impedance path at high frequencies between the conductors. This arrangement provides the lowest possible profile along with a very low inductance and is well suited for high power applications using solid state switching.

### DESCRIPTION OF PRIOR ART

DC Link capacitors are used to manage AC ripple current in inverters and other switched mode power conversion applications. The capacitor is actually a film capacitor winding, also called a section, which is fitted with conductor terminals for interfacing with other components of the inverter circuit. Similarly, DC to DC converters and power supplies use capacitors and capacitor banks for filtering and pulse forming. For traditional systems, the capacitors are connected to a parallel plate bus arrangement with provision being made to isolate the two plates with appropriate voltage withstand. Low inductance is important, as is cost, and the ability for the bus structure to remain relatively cool while handling significant ripple current. This traditional arrangement requires that the capacitor have terminals designed to connect to the bus structure and the bus structure to have a means of accepting them. These connections need to be capable of conducting current with minimal resistive heating, which drives cost and bulk in both the capacitor and the bus structure.

The idea of using a parallel plate bus structure comprised of two conductors to achieve low inductance is well known to those skilled in the art. The inductance of the bus is inversely proportional to the area of the plates and directly proportional to the spacing between them. A dielectric spacer is required to separate the two conductors and is traditionally implemented using a solid layer or discrete pieces of an insulating material. The stray capacitance between the plates is typically on the order of 10 to 1000 pico-Farads. Wound film capacitors are equally well known to those skilled in the art and are commercially available from multiple vendors. Relatively large values on the order of 200-5000 micro-Farads are often required for ripple current filtering in inverter applications and cannot be realized by stray capacitance alone. Such capacitors are constructed using at least two layers of insulating film along with electrodes that can either be discrete metal foils or very thin metal layers directly deposited on the film. The films and electrodes are wound together on a mandrel with the number of layers dictated by the required value of capacitance. Dielectric clearance is required to isolate between the electrodes of opposite potential at each edge of the film. This spacing is defined as the margin and the actual dimension is a function of the voltage. Consider one edge of the capacitor winding where the electrode is extended past the edge of the dielectric to provide a means of connection. The other electrode is terminated well inside the edge of the winding so as to define the margin spacing. Exactly the opposite arrangement is used on the opposite edge of the capacitor. As such, the extended electrodes on the opposite faces of the wound capacitor are electrically insulated from one another.

The idea of using a plurality of wound film capacitor in conjunction with such a bus structure is well known and has been demonstrated for a wide variety of applications including inverter circuits. For example, U.S. Pat. No. 5,388,028 (Arbanas) teaches the idea of using multiple discrete capacitors interconnected with a parallel bus arrangement to achieve a low inductance. Similarly, U.S. Pat. No. 4,517,497 (Malone) teaches the use of an integrated capacitor in SERIES with one bus conductor to create a high speed discharge circuit suitable for generating fast rising current pulses. There is no known prior art that teaches using the insulation between faces of a wound capacitor to act as a dielectric spacer between the plates of a two conductor bus bar. Furthermore, there is no prior art for using a large diameter monolithic single annular form factor capacitor integrated directly into the bus structure.

FIG. 1 illustrates a typical prior art capacitor connected to a parallel plate bus structure. The capacitor is of a construction and terminal design available from many manufacturers, with two threaded studs for clamping the capacitor to the bus structure. Referencing FIG. 1, there is a parallel plate bus structure consisting of two metal layers (11, 12) separated by an insulation layer (13). The capacitor (14) is mounted to the bus structure via two threaded studs (18), each connected to the separate layers of the bus structure (11, 12). A metal insert (19) is installed to keep the same seating plane for both terminals of the capacitor. This insert is welded or soldered to the bus plate (11). Electrical connection actually takes place between the bus plates (11, 12) and the seating shoulders (15) at the capacitor terminals. The clamping force to ensure a good connection is obtained by the threaded stud (18), nuts (17), and washers (16). Given the capacitor construction, this attachment method minimizes the inductance seen by any devices electromechanically connected to this bus structure. However, it can be seen that this attachment method does not make best use of the wound element, as it must be connected to the terminal studs, then bolted to the bus structure. The studs and connection hardware add no value to the assembly except convenience of attaching a capacitor to a specific bus structure. Elimination of the capacitor terminals and attachment hardware would be desirable from cost, complexity, and space efficiency perspectives.

### SUMMARY OF PRESENT INVENTION

The capacitor section is used as the dielectric spacer that electrically isolates the DC bus conductors. This naturally places each end of the capacitor next to a bus plate to reduce greatly any connection hardware. The connections can be made either with a traditional screw terminal with minimal hardware required or by connecting the capacitor section ends directly to the bus plates. If this method is used, reference is made to the teachings of U.S. Pat. No. 7,453,114 B2 (Hosking).

While numerous design and material items will affect the inductance equivalent series inductance (ESL) of the arrangement described, one of the more critical factors is the distance between the plates of the bus bar. Therefore a very short capacitor winding having a diameter much larger than the thickness is expected for this invention. Additionally, an implementation of this invention is the use of compressed ends of the bus structure at the beginning and/or the end of the structure to reduce the total magnetic flux per unit current and hence minimize the inductance. The bus separation is tapered from the maximum spacing defined by the capacitor to a much smaller spacing defined by the voltage requirement.

An additional design element of this invention is the ability to use inexpensive lamination techniques to assemble the bus bars. The entire capacitor and bus plate assembly can also be over coated with an insulating layer to protect against moisture. The complete structure will offer the lowest possible size and weight by virtue of eliminating traditional interface and connection hardware. It should be noted that there is known art of utilizing multi-layer PC boards and their inherent architecture to create a low inductance heavy metal bus structure in the board and place relatively small passive components such as solid dielectric capacitors inside the board between the plates. However, these devices are not intended to, nor designed for carrying the filtering current as being described here and they are not utilizing wound film capacitor components for their filtering.

### DESCRIPTION OF DRAWINGS

FIG. 1 Illustrates [via cross section view] a prior art connection between typical wound film capacitor terminals and a parallel plate bus structure.

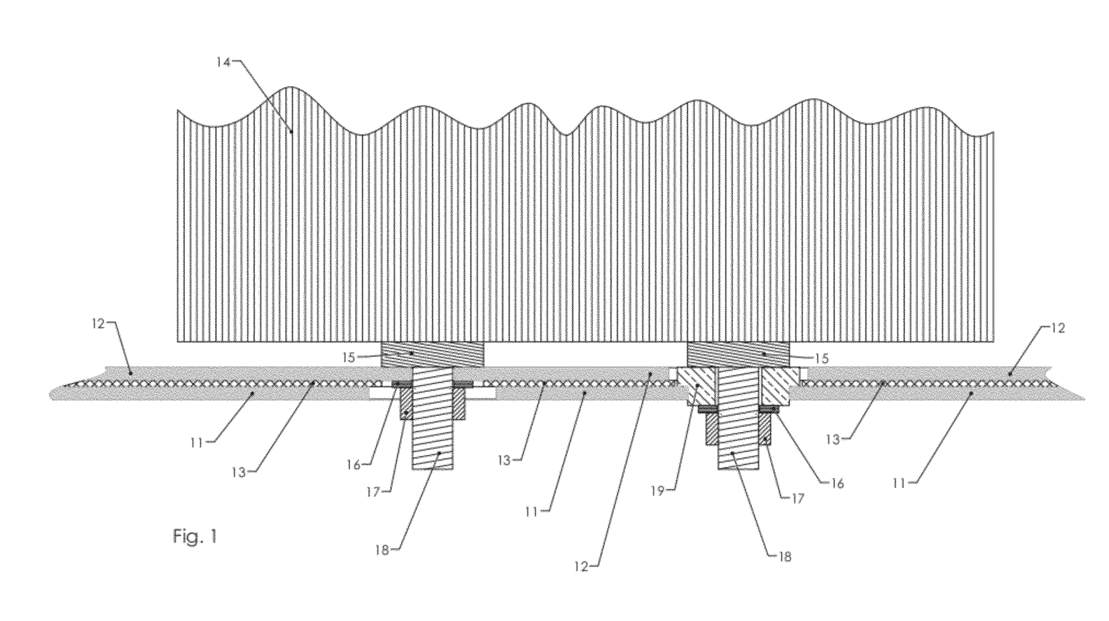

FIG. 2 illustrates a three dimensional cutaway view of the capacitor section used as a spacer between the bus plates.

### DETAILED DESCRIPTION OF THE PREFERRED EMBODIMENTS

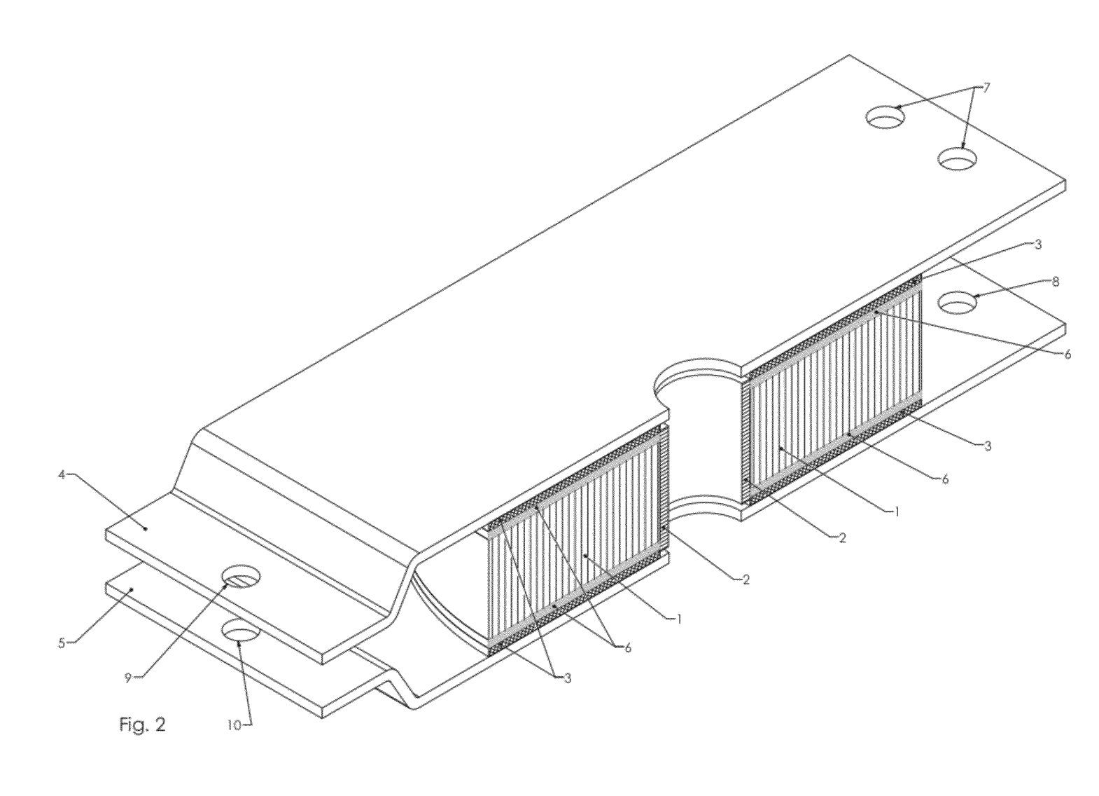

The preferred embodiments of the invention are illustrated in FIG. 2. A large monolithic wound film capacitor 1 having an annular form factor where the diameter is much larger than the height is used as a spacer to isolate the bus conductors 4 and 5. The film capacitor is wound on an insulating core 2 and has a metallic connection 6 on each circular end face both of which are connected to a bus plate through an interface 3. The interface region 3 can be comprised of various configurations, which are addressed under provisional patent No. 61/451,647 Capacitor Used as Insulating Spacer for a High Current Bus Structure (Sawyer, Hosking, and Brubaker). The capacitor winding 1 has internal margins between the electrodes of opposite potential which provide the required insulation between the capacitor terminals 6 and hence the bus plates 4 and 5. The complete capacitor assembly provides a very high capacitance value between the bus plates which is much larger than the stray capacitance between the plates. The capacitor section is very thin in height such that the plate spacing is minimized to achieve the lowest possible inductance. Moving away from the capacitor, the bus plates are tapered so as to move even closer together and maintain the lowest possible inductance. On one side of the capacitor, mounting holes 7 and 8 are provided for connection to the DC source. Similarly, mounting holes 9 and 10 are provided on the opposite end of the bus structure for connection to a solid state switch module after the bus spacing has been compressed.

What is claimed is:

1. I claim everything here noted.

2. A parallel plate bus structure where a film capacitor winding section supports and insulates the bus conductors so that no additional solid dielectric spacer is required. The insulation between the capacitor electrodes is sufficient to withstand the voltage applied between the bus plates. The capacitor is electrically in parallel with the bus conductors.

3. The use of a short height film capacitor for defining the spacing between two parallel bus conductors to provide a large capacitance value and low inductance. The inductance of the structure is directly proportional to the plate spacing. In order to achieve a large capacitance value, a large diameter capacitor winding, or plurality of windings, is required such that the diameter is much smaller than the height. The preferred embodiment of this claim is to have the bus conductor width match or exceed the diameter of the capacitor.

4. The spacing of the bus conductors is reduced at the capacitor edges to minimize the inductance of the structure. The maximum spacing between the bus plates is defined by the width of the capacitor winding and end connections. Moving away from the capacitor, the bus plate spacing is reduced to the minimal value allowed by the applied voltage. A thin layer of insulating material may be utilized to maintain this minimal spacing.

5. A film capacitor winding supporting two parallel bus conductors with the capacitor faces directly connected to the bus conductors such that no other terminals or hardware are required. This includes but is not limited to the use of an electrically conducting adhesive layer, welded joints, soldered joints, a conducting gasket or any other manner of connection between the capacitor end faces and the bus plates.

6. A film capacitor winding supporting two parallel bus structures with any manner of intermediate terminals connecting the bus conductors and capacitor faces. This includes but is not limited to the use of single or braided flexible wires, conducting tabs, conducting foils, or conducting screen, which are connected to the capacitor terminals and bus plates by a suitable method (or combination of methods) including but not limited to welding, soldering, or conducting adhesive.

7. The structures specified in claims 1-6 with a laminated bus conductor arrangement. Said lamination can be applied to the portion of the bus structure away from the capacitor where the minimal plate spacing is achieved using a thin layer of insulation. The lamination process can also include a conformal insulating layer which coats the bus plates or the bus plates and capacitor.
